(19) United States
(12) Patent Application Publication
(10) Pub. No.: US 2012/0256895 A1
(43) Pub. Date: Oct. 11, 2012

(54) DISPLAY DEVICE

(75) Inventors: Kyohko Azumada, Osaka-shi (JP); Tsuyoshi Maeda, Osaka-shi (JP)

(73) Assignee: SHARP KABUSHIKI KAISHA, Osaka-shi, Osaka (JP)

(21) Appl. No.: 13/512,352

(22) PCT Filed: Oct. 21, 2010
(86) PCT No.: PCT/JP2010/068623

§ 371 Date: May 29, 2012

(30) Foreign Application Priority Data
Dec. 28, 2009 (JP) 2009-298759

(51) Int. Cl. G09G 3/36; G09G 5/00

(52) U.S. Cl. 345/211; 345/87

(57) ABSTRACT

A display device (1) includes: a PDLC panel (5), which covers a display surface formed by a display part (2a) and a peripheral section (4a), and which, while directly transmitting incident light when a voltage is applied, scatters incident light when no voltage is applied; and a voltage application control circuit (31), which carries out such control that when a display is carried out on the display surface, a voltage is applied from a power supply (v1) to the PDLC panel (5), and when no display is carried out on the display surface, the voltage is not applied from the power supply (V1) to the PDLC panel (5).

### TECHNICAL FIELD

The present invention relates to display devices.

### BACKGROUND ART

Various displays (display devices) such as liquid crystal displays, plasma displays, and organic EL displays do not show images when the power is off. As in the case of a display device 101 of (a) of FIG. 10 to be described later, the whole display is seen as a black object when the power is off. Consequently, when the power is off, the display is very conspicuous in a space, thus greatly affecting the appearance of the space.

The design of conventional display devices (e.g., televisions) often uses housings whose color tone is based on black. Further, for example, that part of a conventional liquid crystal display device which shows an image is in such a state as follows when it does not show an image: First, the light source is off; second, two polarizers are placed with their transmission axes orthogonal to each other; and third, pixels corresponding to each separate color of a color filter have their light transmittance reduced to ⅓. Therefore, when the power is off (when OFF), the conventional display device is seen as a black object.

FIG. 10 is a set of explanatory diagrams (a) and (b) of a conventional display device 101. (a) of FIG. 10 is a front view showing the conventional display device 101 with no image displayed, and (b) of FIG. 10 is a front view showing the conventional display device 101 with an image displayed. Home displays, in particular nowadays, have grown in size, and have thus come to more greatly affect a space.

It should be noted here that as an invention directed to a display device including a protective plate, Patent Literature 1 discloses a display device including a transparent protective plate placed on a front surface of a liquid crystal display, with the space between the liquid crystal display and the protective plate filled with a transparent substance equivalent in refractive index to the liquid crystal display and the protective plate, so as to prevent surface reflection on a back surface of the protective plate and a surface of the liquid crystal display. Further, Patent Literature 2 discloses a reflection preventing layer (reflection preventing film), formed on a surface of a polymer film, which reduces reflection in a visible light range.

### CITATION LIST

### Patent Literature 1

Japanese Patent Application Publication, Tokukaihei, No. 3-204616 A (Publication Date: Sep. 6, 1991)

### Patent Literature 2

Japanese Patent Application Publication, Tokukai, No. 2005-156695 A (Publication Date: Jun. 16, 2005)

### SUMMARY OF INVENTION

### Technical Problem

FIG. 11, which is equivalent to FIG. 1 of Patent Literature 1, is a cross-sectional view showing a conventional liquid crystal display device 102. The liquid crystal display device 102 includes a transparent protective plate 103, and prevents surface reflection by filling the inside of a frame 105 provided between a liquid crystal display element 104 and the protective plate 103 with a transparent substance 106 equivalent in refractive index to the liquid crystal display element 104 and the protective plate 103. The liquid crystal display device 102 also includes a surface reflection preventing film 107 formed on a surface of the protective film 103.

However, the protective film 103 of FIG. 11 is made solely of an acrylic or glass plate. For this reason, the liquid crystal display device 102 cannot switch colors on its surface when seen on the surface. Consequently, when the power is off, the liquid crystal display device 102 continues to exist as a black object. Therefore, the liquid crystal display device 102 greatly affects the appearance of a space (e.g., a room) in which it is placed, i.e., has such a problem as to spoil the appearance of the space in which it is placed.

The present invention has been made in view of the foregoing conventional problems, and it is an object of the present invention to provide a display device which can be made less conspicuous in a space than a conventional display device, which does not spoil the whole appearance of a space (e.g., a room) in which it is placed, and which can help improve interior design.

### Solution to Problem

In order to solve the foregoing problems, a display device of the present invention is a display device including a display surface formed by a display region and a non-display region, comprising: a protective panel, which covers the display surface, and which, while directly transmitting incident light when a voltage is applied, scatters incident light when no voltage is applied; and voltage application control means, which carries out such control that when a display is carried out on the display surface, a voltage is applied from a power supply to the protective panel, and when no display is carried out on the display surface, the voltage is not applied from the power supply to the protective panel.

According to the foregoing invention, the display device includes a protective panel. The protective panel is a panel which, while directly transmitting incident light when a voltage is applied, scatters incident light when no voltage is applied.

In the display device, the voltage application control means causes a voltage to be applied from the power supply to the protective panel when a displayed is carried out on the display surface. This allows the protective panel to directly transmit incident light, so that the image displayed by the display panel can been seen as per normal.

Meanwhile, the voltage application control means does not cause a voltage to be applied from the power supply to the protective panel when no displayed is carried out on the display surface. This causes light incident on the protective panel to be scattered, so that the display device gives a white appearance on its surface, for example.

Thus, since, when the display device does not carry out a display, the display surface of the display device turns white, the display device can be made less conspicuous in a space than a conventional display device. Take the case of a display hung on a wall or embedded in a wall, for example. Since walls are mostly white and the display device gives a white appearance similar in color to such white walls, the display device does not spoil the whole appearance of a space (e.g., a room) in which it is placed, and can also help improve interior design.

### Advantageous Effects of Invention

As described above, a display device of the present invention includes: a protective panel, which covers the display surface, and which, while directly transmitting incident light when a voltage is applied, scatters incident light when no voltage is applied; and voltage application control means, which carries out such control that when a display is carried out on the display surface, a voltage is applied from a power supply to the protective panel, and when no display is carried out on the display surface, the voltage is not applied from the power supply to the protective panel.

This brings about an effect of providing a display device which can be made less conspicuous in a space than a conventional display device, which does not spoil the whole appearance of a space (e.g., a room) in which it is placed, and which can help improve interior design.

### BRIEF DESCRIPTION OF DRAWINGS

FIG. 1 is a set of explanatory diagrams (a) and (b) of a liquid crystal display according to an embodiment of the present invention, (a) being a cross-sectional view of the liquid crystal display according to the embodiment of the present invention, (b) being a front view of a display part of a liquid crystal panel of the liquid crystal display and a peripheral section of the liquid crystal display, the peripheral section covering the display part.

FIG. 2 is a cross-sectional view showing a detailed configuration of a PDLC panel in the liquid crystal display of FIG. 1.

FIG. 3 is a set of explanatory diagrams (a) and (b) of whether or not a voltage is applied to the PDLC panel, (a) being a cross-sectional view showing that when a voltage is applied to the liquid crystal panel of FIG. 1 and an image is displayed on the liquid crystal panel (when the power is ON), a voltage is applied to the PDLC panel, too, (b) being a cross-sectional view showing that when no voltage is applied to the liquid crystal panel of FIG. 1 and no image is displayed on the liquid crystal panel (when the power is OFF), no voltage is applied to the PDLC panel, either.

FIG. 4 is a set of front views (a) and (b) of the liquid crystal display of FIG. 1, (a) being a front view of the liquid crystal display of FIG. 1 with an image displayed thereby, (b) being a front view of the liquid crystal display of FIG. 1 with no image displayed thereby.

FIG. 5 is a set of explanatory diagrams (a) and (b) of a liquid crystal display according to another embodiment of the present invention, (a) being a cross-sectional view of the liquid crystal display according to the embodiment of the present invention, (b) being a front view showing a PDLC panel of the liquid crystal display and a peripheral section of the liquid crystal display, the peripheral section covering the PDLC panel.

FIG. 6 is a cross-sectional view showing a detailed configuration of the PDLC panel in the liquid crystal display of FIG. 5.

FIG. 7 is a set of explanatory diagrams (a) and (b) of whether or not a voltage is applied to the PDLC panel, (a) being a cross-sectional view showing that when a voltage is applied to the liquid crystal panel of FIG. 5 and an image is displayed on the liquid crystal panel (when the power is ON), a voltage is applied to the PDLC panel, too, (b) being a cross-sectional view showing that when no voltage is applied to the liquid crystal panel of FIG. 5 and no image is displayed on the liquid crystal panel (when the power is OFF), no voltage is applied to the PDLC panel, either.

FIG. 8 is a set of diagrams (a) and (b) showing a liquid crystal display displaying an image and a liquid crystal display displaying no image, respectively, (a) being a front view of the liquid crystal display of FIG. 5 with an image displayed thereby, (b) being a front view of the liquid crystal display of FIG. 5 with no image displayed thereby.

FIG. 9 is a block diagram showing a driver that drives the liquid crystal panel in the liquid crystal display of FIG. 1.

FIG. 10 is a set of explanatory diagrams (a) and (b) of a conventional display device, (a) being a front view showing the conventional display device with no image being displayed, (b) being a front view showing the conventional display device with an image being displayed.

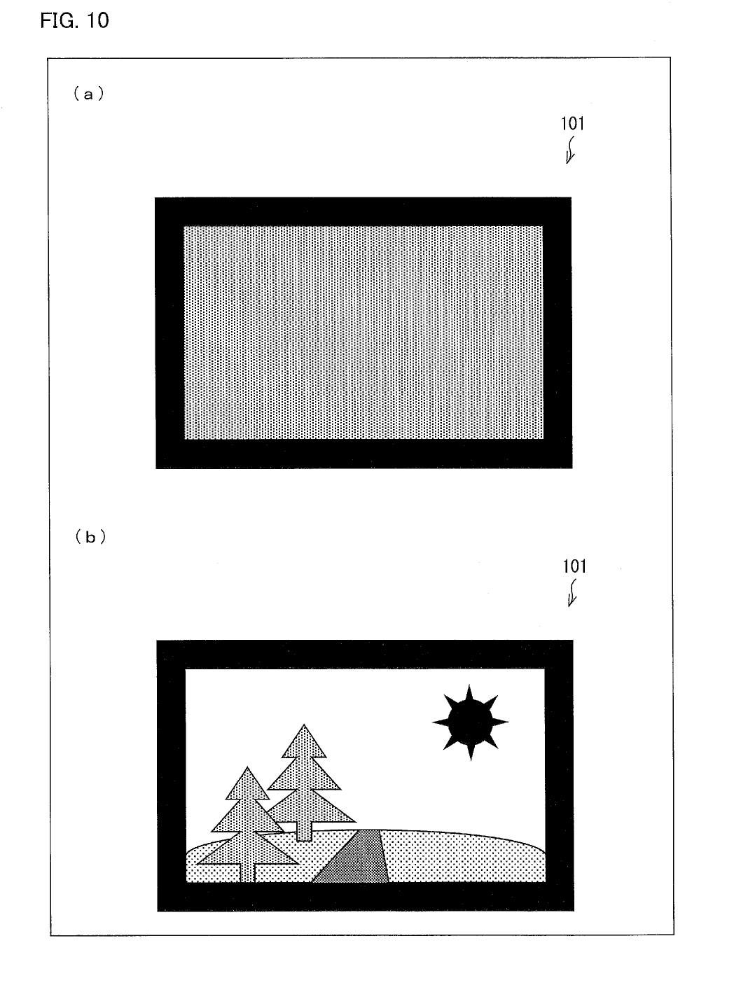

FIG. 11 is a cross-sectional view showing a conventional liquid crystal display device.

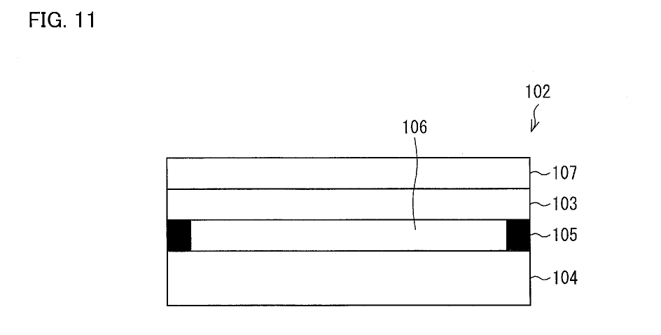

### DESCRIPTION OF EMBODIMENTS

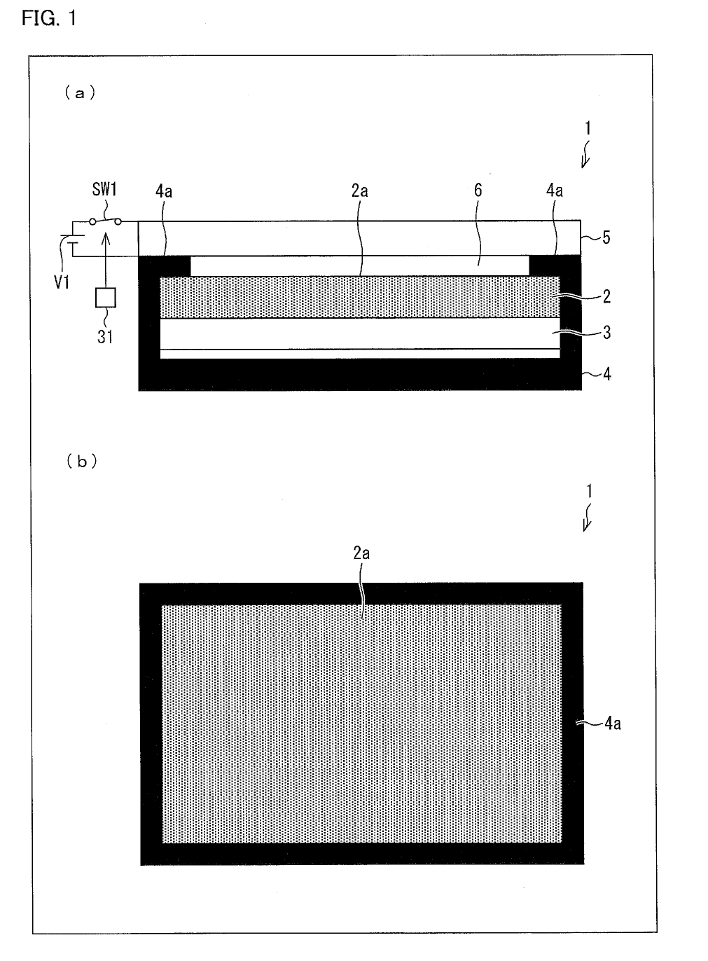

Embodiments 1 and 2 of the present invention are described below with reference to FIGS. 1 through 8.

### Embodiment 1

Embodiment 1 of the present invention is described below with reference to FIGS. 1 through 4 and FIG. 9.

FIG. 1 is a set of explanatory diagrams (a) and (b) of a liquid crystal display 1 according to Embodiment 1. (a) of FIG. 1 is a cross-sectional view of the liquid crystal display (display device) according to Embodiment 1, and (b) of FIG. 1 is a front view of a display part 2a (display region) of a liquid crystal panel (display panel) 2 of the liquid crystal display 1 and a peripheral section 4a (non-display region) of the liquid crystal display 1, the peripheral section 4a covering the display part 2a. The peripheral section 4a is part of a housing 4, and the display part 2a and the peripheral section 4a form a display surface.

For the purpose of explaining the display part 2a and the peripheral section 4a, (b) of FIG. 1 omits to illustrate a PDLC panel (protective panel, polymer dispersed liquid crystal panel) 5 to be described later; however, in actuality, as shown in (a) of FIG. 1, the PDLC panel 5 is provided so as to cover the display part 2a and the peripheral section 4a. PDLC stands for Polymer Dispersed Liquid Crystal.

The protective panel in Embodiment 1 is a panel which covers the display surface formed by the display part 2a and the peripheral section 4a, and which has a switching function of, while directly transmitting incident light when a voltage is applied, scattering incident light when no voltage is applied.

The liquid crystal display 1 includes: the liquid crystal panel 2 provided with the display surface; a backlight unit 3, which serves as a light source; the housing 4, which immobilizes the liquid crystal panel 2 and the backlight unit 3, and which covers other parts of the liquid crystal panel 2 than the display part 2a (display surface); and the PDLC panel (polymer liquid crystal panel) 5, which covers the display part 2a (display surface) and the peripheral section 4. In the housing 4, the backlight unit 3 and the liquid crystal panel 2 are placed in this order.

[PDLC Panel 5]

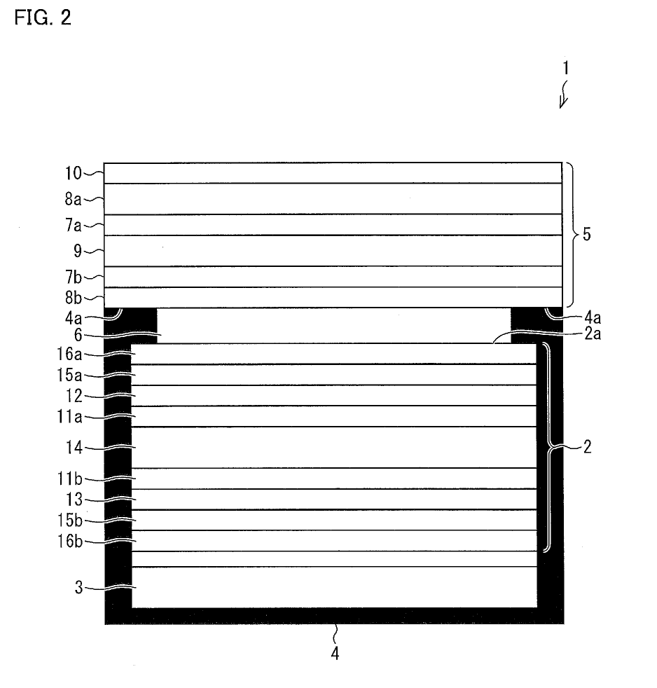

FIG. 2 is a cross-sectional view showing a detailed configuration of the PDLC panel 5 in the liquid crystal display 1 of FIG. 1. As shown in FIG. 2, the PDLC panel 5 has a PDLC layer (polymer dispersed liquid crystal layer) 9 sandwiched between a transparent electrode 7a formed on a glass substrate 8a and a transparent electrode 7b formed on a glass substrate 8b. Formed on an upper surface the glass substrate 8a, which serves as a front plate of the liquid crystal display 1, is a reflection preventing film 10 for suppressing a decrease in visibility due to reflection of outside light on the front plate. The reflection preventing film 10 is exposed as an uppermost surface of the liquid crystal display 1. The transparent electrodes 7a and 7b are for example made of ITO.

Thus, in the PDLC panel 5, the glass substrate 8b, the transparent electrode 7b, the PDLC layer 9, the transparent electrode 7a, the glass substrate 8a, and the reflection preventing film 10 are stacked in this order of proximity to the display part 2a of the liquid crystal panel 2.

In the PDLC panel 5, a moth-eye film is used as the reflection preventing film 10. The moth-eye film is a film obtained by periodically arranging, on a surface of a polymer film, tapered projections that are finer than the wavelength of light. Adoption of a film having such a shape causes a continuous change in through-thickness refractive index, thus allowing suppression of reflection of visible light.

As described for example in Patent Literature 2 (Japanese Patent Application Publication, Tokukai, No. 2005-156695 A), such a moth-eye film is fabricated by, with use of an anodized porous alumina as a mold, transferring the shape of the mold to a polymer film.

[Liquid Crystal Panel 2]

A configuration of the liquid crystal panel 2 is described below with reference to FIG. 2. The liquid crystal panel 2 has a liquid crystal layer 14 sandwiched between a transparent electrode 11a formed on a color filer substrate (CF substrate) 12 and a transparent electrode 11b formed on a TFT substrate 13. Further formed on an outer side of the color filter substrate 12 is a viewing angle compensation film 15a provided on a polarizer 16a, and formed on an outer side of the TFT substrate 13 is a viewing angle compensation film 15b provided on a polarizer 16b.

Thus, in the liquid crystal panel 2, the polarizer 16b, the viewing angle compensation film 15b, the TFT substrate 13, the transparent electrode 11b, the liquid crystal layer 14, the transparent electrode 11a, the color filter substrate 12, the viewing angle compensation film 15a, and the polarizer 16a are stacked in this order of proximity to the backlight unit 3.

[Air Layer 6 or a Gel Layer 6]

Embodiment 1 has an air layer 6 between the liquid crystal panel 2 and the PDLC panel 5. Alternatively, Embodiment 1 may have a gel layer 6 formed by joining the liquid crystal panel 2 and the PDLC panel 5 to each other with a gel adhesive.

In general, there occurs reflection at the interface between substances having different refractive indices. Therefore, the presence of the air layer 6 as in the foregoing configuration causes reflection of outside light on the surface of the liquid crystal panel 2, thus causing a decrease in visibility.

In order to prevent such reflection of outside light, the gel layer 6 is formed between the PDLC panel 5 and the liquid crystal panel 2 by joining the liquid crystal panel 2 and the PDLC panel 5 to each other with a gel adhesive equivalent in refractive index to the liquid crystal panel 2 and the PDLC panel 5. This makes it possible to suppress reflection of outside light and reflection at the interface, thus making it possible to suppress a decrease in visibility of an image.

[Guest-Host Dye (Dichroic Dye)]

In Embodiment 1, a guest-host dye (dichroic dye) may be added into the PDLC layer 9. The guest-host dye, dissolved in liquid crystals aligned in a given molecular arrangement, has its dye molecules aligned in parallel with the liquid crystal molecules. This allows the guest-host dye to change its orientation in accordance with a change in orientation of the liquid crystal molecules in the presence of an electric field, thus making it possible to change the amount of visible light that the dichroic dye absorbs.

Therefore, addition of the guest-host dye (dichroic dye) to the PDLC layer 9 of the PDLC panel 5 allows the PDLC panel 5 to switch between a transparent state and a colored state according to the presence or absence of a voltage applied between the transparent electrode 7a and the transparent electrode 7b.

[Cholesteric Liquid Crystals]

In Embodiment 1, cholesteric liquid crystals may be added into the PDLC layer 9. The cholesteric liquid crystals are liquid crystals whose molecules have a helical structure. In cases where the molecules have a helical structure of a given period with its helical axis perpendicular to the plane of a substrate and where the period of the helix is equal to a particular wavelength of light, light of that wavelength is reflected. Consequently, use of cholesteric liquid crystals equal in period to a particular wavelength renders a colored state since light of that wavelength is reflected; meanwhile, all light can be transmitted by laying the helical molecules of the cholesteric liquid crystals by the application of a voltage.

Therefore, addition of the cholesteric liquid crystals to the PDLC layer 9 of the PDLC panel 5 allows the PDLC panel 5 to switch between a transparent state and a colored state according to the presence or absence of a voltage applied between the transparent electrode 7a and the transparent electrode 7b.

[Polymer Dispersed Liquid Crystals (PDLCs)]

Polymer dispersed liquid crystals (PDLCs) have a structure in which the liquid crystal molecules are phased-separated within a polymer. The application of voltage to PDLCs causes the liquid crystal molecules to face in the same direction, so that the polymer region and the liquid crystal region become equal in refractive index to each other. This allows incident light to be directly transmitted.

On the other hand, when no voltage is applied, the liquid crystals face in random directions, so that the polymer region and the liquid crystal region are different in refractive index to each other. This causes incident light to be scattered to look white.

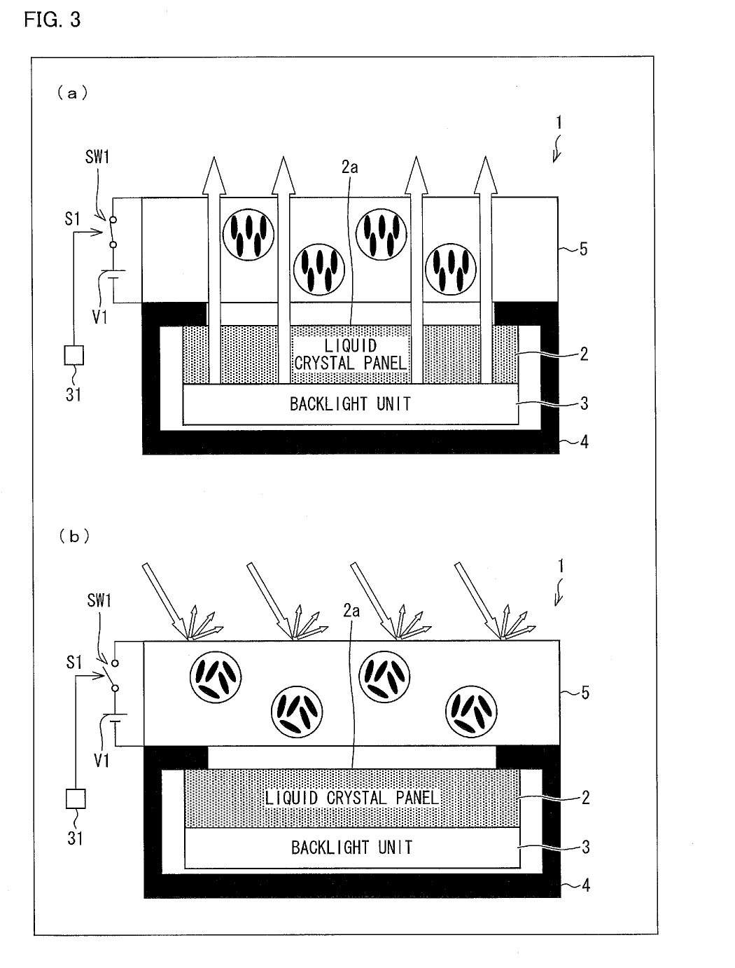

FIG. 3 is a set of explanatory diagrams (a) and (b) of whether or not a voltage is applied to the PDLC panel 5. The liquid crystal display 1 utilizes the aforementioned properties of PDLCs. That is, when the liquid crystal panel 2 carries out a display (when a voltage is applied to the liquid crystal panel 2 and an image is displayed on the liquid crystal panel 2 (when the power is ON)), a voltage application control circuit (voltage application control means) 31 causes a voltage to be applied the PDLC panel 5 from a voltage supply V1 to be described later ((a) of FIG. 3). This causes the PDLC panel 5 to be transparent, so that the image displayed by the liquid crystal panel 2 can be seen as per normal.

For the application of voltage to the PDLC panel 5, the voltage supply V1 and a switch SW1, both had by the voltage application control circuit 31, are used, for example. The voltage supply V1 and the switch SW1 are connected in series to constitute a voltage application circuit. The switch SW1 has one end connected to the transparent electrode 7a. The other end of the switch SW1 is connected to an output of the voltage supply V1. The voltage supply V1 has its input connected to the transparent electrode 7b.

The voltage application control circuit 31 detects whether or not a driver that drives the liquid crystal panel 2 is operating (outputting signals) and, if it is, outputs a control signal to the switch SW1 to supply a voltage to the PDLC panel 5 from the voltage supply V1. The driver that drives the liquid crystal panel 2 will be described later.

Meanwhile, when the liquid crystal panel 2 does not carry out a display (when no voltage is applied to the liquid crystal panel and no image is displayed on the liquid crystal panel 2 (when the power is OFF)), the voltage application control circuit 31 does not cause a voltage to be applied to the PDLC panel 5 from the voltage supply V1 ((b) of FIG. 3). This causes the PDLC panel 5 to scatter outside light on its surface, so that the liquid crystal display 1 gives a white appearance on its surface.

As shown in (a) of FIG. 1, the PDLC layer 9 of the PDLC panel 5 is placed in such a way as to cover up the housing 4 of the liquid crystal panel 2. While, in the case of a normal display, the housing part (which corresponds to the peripheral section 4a of FIG. 1) and the display part (which corresponds to the display part 2a of FIG. 1) are separate regions, the foregoing configuration makes the housing part and the display part appear to be a single plate.

Further, the voltage supply V1 may be a variable voltage supply the value of whose output voltage is variable.

[Design Improvements in the Liquid Crystal Display 1]

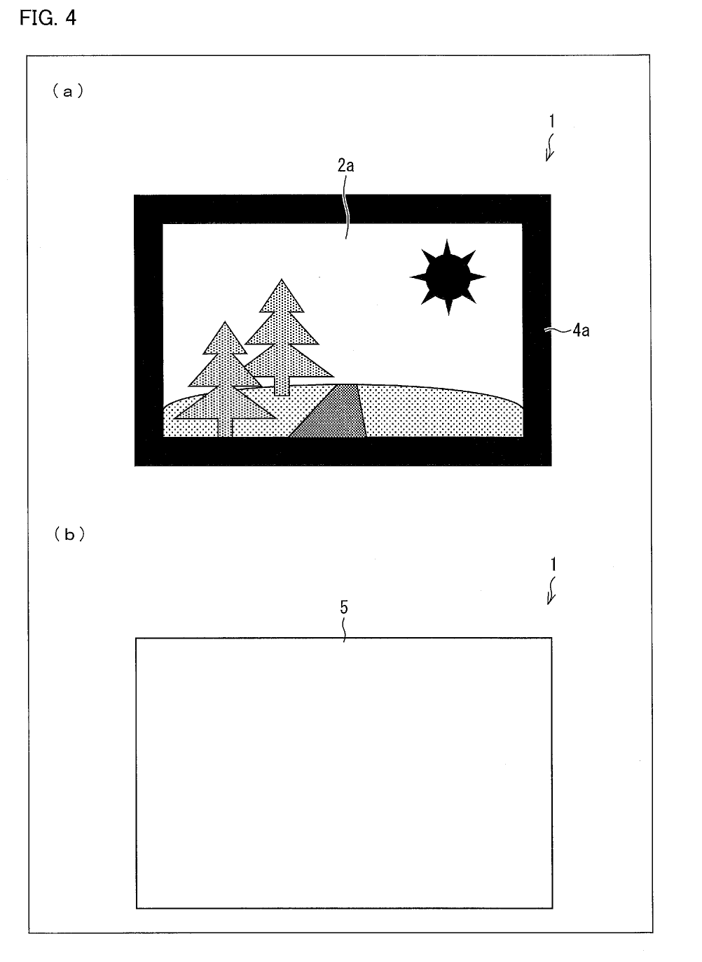

FIG. 4 is a set of front views (a) and (b) of the liquid crystal display 1 of FIG. 1. As shown in (a) of FIG. 4, when the liquid crystal display 1 shows an image (when an image is displayed), the application of voltage to the PDLC panel 5 causes the PDLC panel 5 to be transparent. Consequently, the image can be seen as per normal.

Meanwhile, as shown in (b) of FIG. 4, when the liquid crystal display 1 does not show an image (no image is displayed), no voltage is applied to the PDLC panel 5. Consequently, scattering of light on the surface of the PDLC panel 5 makes the PDLC panel 5 look white as if it were a single white plate.

Usually, when the power is off, a display is very conspicuous in a space in the form of a black object. The larger the display is in size, the more conspicuous it is in the space.

However, the liquid crystal display 1 according to Embodiment 1 has the foregoing configuration. Consequently, since the display surface turns white when no image is displayed, the liquid crystal display 1 can be made less conspicuous in a space than a conventional display. Take the case of a display hung on a wall or embedded in a wall, for example. Since walls are mostly white and the liquid crystal display 1 gives a white appearance similar in color to such white walls, the liquid crystal display 1 does not spoil the whole appearance of a space (e.g., a room) in which it is placed, and can also help improve interior design.

Further, as mentioned above, addition of a guest-host dye or cholesteric liquid crystals into the PDLC layer 9 causes the PDLC panel 5 to be transparent when an image is displayed. Consequently, the image can be seen as per normal. Meanwhile, when no image is displayed, the PDLC panel 5 looks colored, thus allowing a wider variety of designs.

[Driver That Drives the Liquid Crystal Panel 2]

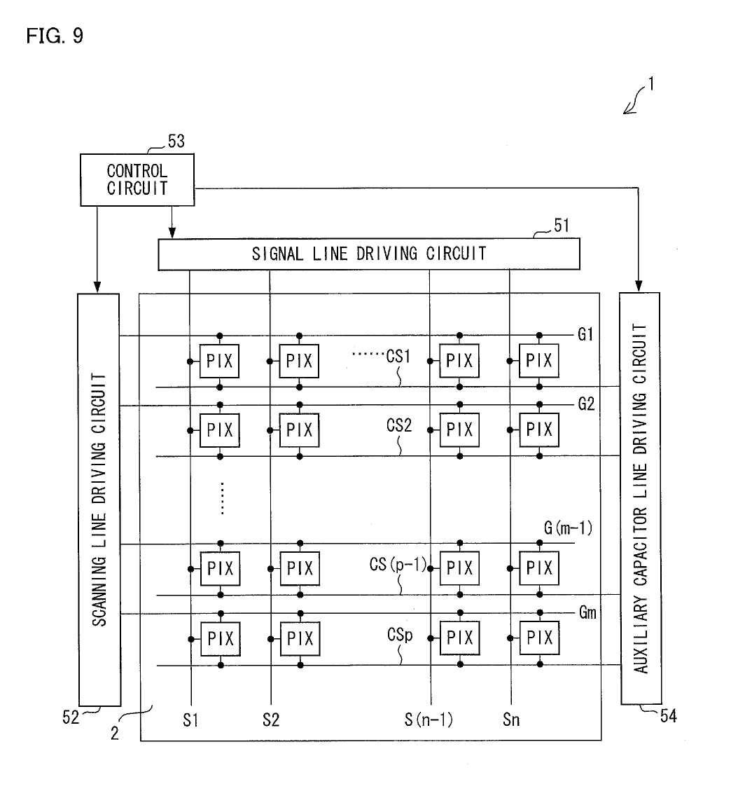

FIG. 9 is a block diagram showing the driver that drives the liquid crystal panel 2 in the liquid crystal display 1. The liquid crystal display 1 includes: the liquid crystal panel 2; a signal line driving circuit 51, which drives signal lines S1, S2, . . . S(n−1), and Sn; a scanning line driving circuit 52, which drives scanning lines G1, G2, . . . G(m−1), and Gm; a control circuit 53; and an auxiliary capacitor line driving circuit 54, which drives auxiliary capacitor lines CS1, CS2, . . . CS(p−1), and CSp connected to auxiliary capacitors provided inside pixels PIX. The signal line driving circuit 51, the scanning line driving circuit 52, the control circuit 53, and the auxiliary capacitor line driving circuit 54 constitute the driver.

Let it be assumed that the signal lines S1, S2, . . . S(n−1), and Sn extend in a column-wise direction. Then, each column of pixels PIX arranged in the column-wise direction is provided with a single signal line. Further, let it be assumed also that the scanning lines G1, G2, . . . G(m−1), and Gm extend in a row-wise direction. Then, each row of pixels PIX arranged in the row-wise direction is provided with a single scanning line.

Each of the pixels PIX has a TFT and a pixel electrode (both not illustrated). The TFTs have their gates connected to the scanning lines G1, G2, . . . G(m−1), and Gm, respectively, and have their sources connected to the signal lines S1, S2, . . . S(n−1), and Sn. Further, the pixel electrodes are connected to the drains of the TFTs, respectively, and the auxiliary capacitor lines CS1, CS2, . . . CS(p−1), and CSp correspond to the pixel electrodes, respectively.

### Embodiment 2

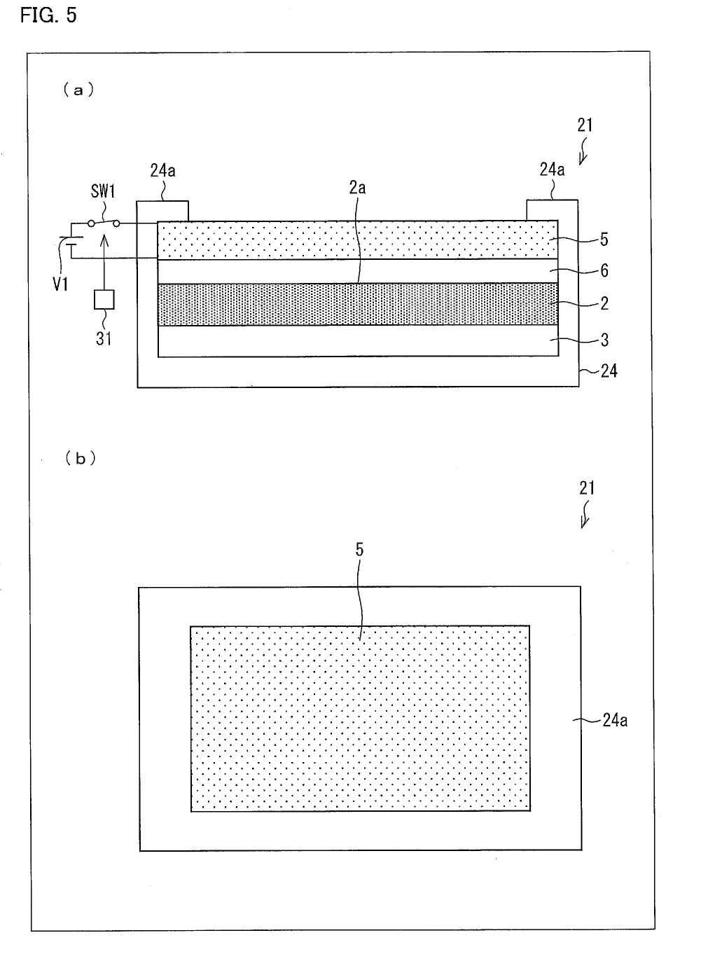

Another embodiment of the present invention is described below with reference to FIGS. 5 through 8. Components other than those described below in Embodiment 2 are the same as those described above in Embodiment 1. For convenience of explanation, members having the same functions as those shown above in the drawings of Embodiment 1 are give the same reference signs, and as such, are not described below.

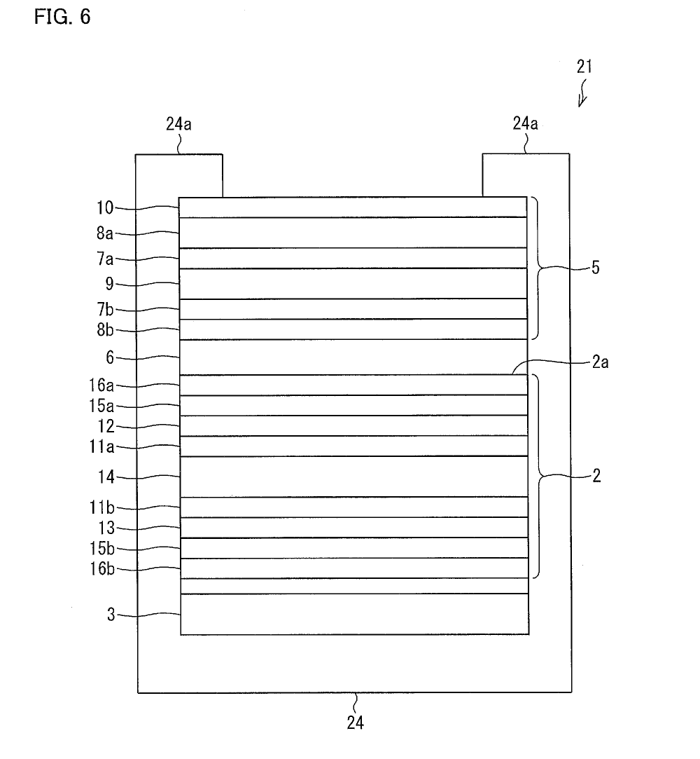

FIG. 5 is a set of explanatory diagrams (a) and (b) of a liquid crystal display 21 according to Embodiment 2. (a) of FIG. 5 is a cross-sectional view of the liquid crystal display (display device) 21 according to Embodiment 2, and (b) of FIG. 5 is a front view of a PDLC panel 5 of the liquid crystal display 21 and a peripheral section 24a of the liquid crystal display 21, the peripheral section 24a covering the periphery of the PDLC panel 5. The peripheral section 24a is part of a housing 24. In the housing 24, the backlight unit 3, the liquid crystal panel 2, and the PDLC panel 5 are placed in this order. FIG. 6 is a cross-sectional view showing a detailed configuration of the PDLC panel 5 in the liquid crystal display 21 of FIG. 5.

[Differences Between the Liquid Crystal Display 21 and the Liquid Crystal Display 1]

A first difference between the liquid crystal display 21 according to Embodiment 2 and the liquid crystal display 1 according to Embodiment 1 is the colors of their housings. That is, while the housing 4 of the liquid crystal display 1 according to Embodiment 1 is black, the housing 24 of the liquid crystal display 21 according to Embodiment 2 is white.

Although housings are mostly designed to have color tones based mainly on black or silver, some displays have housings whose colors are other than those mentioned above, in consideration of design improvements and balance with the interior.

In the liquid crystal display 21 according to Embodiment 2, the PDLC panel 5 is provided above the liquid crystal panel 2 with an air layer 6 sandwiched therebetween, and the housing 24, which is white, is provided so as to immobilize the liquid crystal panel 2, the PDLC panel 5, and the air layer 6.

A second difference between the liquid crystal display 21 according to Embodiment 2 and the liquid crystal display according to Embodiment 1 is the structures of their housings. That is, in the liquid crystal display 1 according to Embodiment 1, the PDLC panel 5 is provided outside the housing 4, so that when the liquid crystal display 1 is not showing an image, the PDLC panel 5, which is being white, is seen from the side on which an image is displayed.

On the other hand, in the liquid crystal display 21 according to Embodiment 2, the PDLC panel 5 is placed inside the housing 24. When the liquid crystal display 21 is not showing an image, the PDLC panel 5, which is being white, and the peripheral section 24a, which is white, of the housing 24 are seen from the side on which an image is displayed.

In this way, the color that the PDLC panel 5 takes on when the liquid crystal display 21 does not carry out a display may be the same as the color of the peripheral section 24a.

[Modification of the Liquid Crystal Display 21]

The liquid crystal display 21 according to Embodiment 2 has the air layer 6 between the liquid crystal panel 2 and the PDLC panel 5, but may alternatively have a gel layer 6 formed by joining the liquid crystal panel 2 and the PDLC panel 5 to each other with a gel adhesive.

Further, the housing 24 of the liquid crystal display 21 according to Embodiment 2 is white, but may alternatively be made another color.

Furthermore, in the liquid crystal display 21 according to Embodiment 2, a guest-host dye (dichroic dye) may be added into the PDLC layer 9. In so doing, a guest-host dye whose color matches the color of the housing may be selected.

Furthermore, in the liquid crystal display 21 according to Embodiment 2, cholesteric liquid crystals may be added into the PDLC layer 9. In so doing, cholesteric liquid crystals having the same helical period as the wavelength of the color of the housing may be selected.

[Polymer Dispersed Liquid Crystals (PDLCs)]

Polymer dispersed liquid crystals (PDLCs) have a structure in which the liquid crystal molecules are phased-separated within a polymer. The application of voltage to PDLCs causes the liquid crystal molecules to face in the same direction, so that the polymer region and the liquid crystal region become equal in refractive index to each other. This allows incident light to be directly transmitted.

On the other hand, when no voltage is applied, the liquid crystals face in random directions, so that the polymer region and the liquid crystal region are different in refractive index to each other. This causes incident light to be scattered to look white.

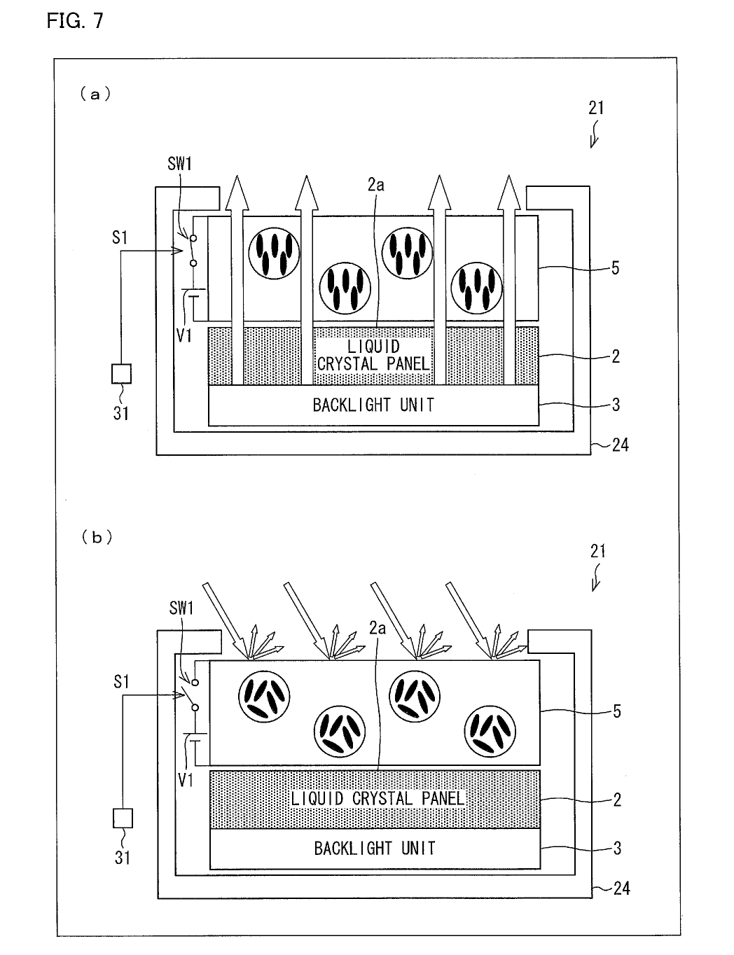

FIG. 7 is a set of explanatory diagrams (a) and (b) of whether or not a voltage is applied to the PDLC panel 5. The liquid crystal display 21 according to Embodiment 2, as with the liquid crystal display 1 according to Embodiment 1, utilizes the aforementioned properties of PDLCs. That is, when a voltage is applied to the liquid crystal panel 2 and an image is displayed on the liquid crystal panel 2 (when the power is ON), a voltage is applied to the PDLC panel 5, too ((a) of FIG. 7). This causes the PDLC panel 5 to be transparent, so that the image displayed by the liquid crystal panel 2 can be seen as per normal.

For the application of voltage to the PDLC panel 5, the voltage supply V1 and the switch SW1 are used, for example. The switch SW1 has one end connected to the transparent electrode 7a. The other end of the switch SW1 is connected to an output of the voltage supply V1. The voltage supply V1 has its input connected to the transparent electrode 7b.

Meanwhile, when no voltage is applied to the liquid crystal panel 2 and no image is displayed on the liquid crystal panel 2 (when the power is OFF), no voltage is applied to the PDLC panel 5, either ((b) of FIG. 7). This causes the PDLC panel 5 to scatter outside light on its surface, so that the PDLC panel 5 turns white. Further, the housing 24 of the liquid crystal display 21 is white. Therefore, when no image is displayed, the surface of the liquid crystal display 21 looks white because of the white PDLC panel 5 and the peripheral section 24a of the white housing 24.

[Design Improvements in the Liquid Crystal Display 21]

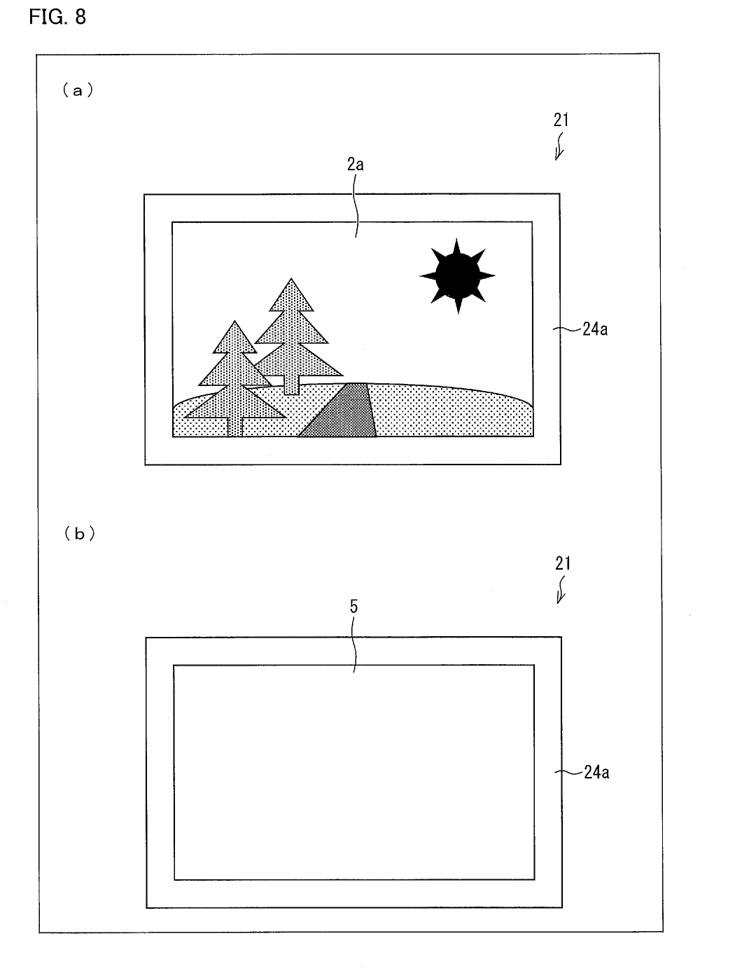

FIG. 8 is a set of diagrams (a) and (b) showing the liquid crystal display 21 showing an image and the liquid crystal display showing no image, respectively. As shown in (a) of FIG. 8, when the liquid crystal display 21 shows an image (when an image is displayed), the application of voltage to the PDLC panel 5 causes the PDLC panel 5 to be transparent. Consequently, the image can be seen as per normal.

Meanwhile, as shown in (b) of FIG. 8, when the liquid crystal display 21 does not show an image (no image is displayed), no voltage is applied to the PDLC panel 5. Consequently, scattering of light on the surface of the PDLC panel 5 makes the PDLC panel 5 look white. Further, the housing 24 of the liquid crystal display 21 is white. Therefore, when no image is displayed, the surface of the liquid crystal display 21 looks white because of the white PDLC panel 5 and the peripheral section 24a of the white housing 24.

Usually, when the power is off, a display is very conspicuous in a space in the form of a black object. The larger the display is in size, the more conspicuous it is in the space.

However, the liquid crystal display 21 according to Embodiment 2 has the foregoing configuration. Consequently, since the display surface turns white when no image is displayed, the liquid crystal display 21 can be made less conspicuous in a space than a conventional display having display surface whose color includes black or silver. Take the case of a display hung on a wall or embedded in a wall, for example. Since walls are mostly white and the liquid crystal display 21 gives a white appearance similar in color to such white walls, the liquid crystal display 21 does not spoil the whole appearance of a room, and can also help improve interior design.

Further, as mentioned above, addition of a guest-host dye or cholesteric liquid crystals into the PDLC layer 9 causes the PDLC panel 5 to be transparent when an image is displayed. Consequently, the image can be seen as per normal. Meanwhile, when no image is displayed, the PDLC panel 5 looks colored, thus allowing a wider variety of designs.

The display device may be configured such that the protective panel is a polymer dispersed liquid crystal panel.

According to the foregoing invention, the display device includes a polymer dispersed liquid crystal panel. Polymer dispersed liquid crystals (PDLCs) have a structure in which the liquid crystal molecules are phased-separated within a polymer. The application of voltage to PDLCs causes the liquid crystal molecules to face in the same direction, so that the polymer region and the liquid crystal region become equal in refractive index to each other. This allows incident light to be directly transmitted.

On the other hand, when no voltage is applied, the liquid crystals face in random directions, so that the polymer region and the liquid crystal region are different in refractive index to each other. This causes incident light to be scattered to look white.

The display device utilizes the aforementioned properties of polymer dispersed liquid crystals. That is, when the display panel carries out a display, the voltage application control means causes a voltage to be applied from the power supply to the polymer dispersed liquid crystal panel. This causes the polymer dispersed liquid crystal panel to be transparent, so that the image displayed by the display panel can be seen as per normal.

Meanwhile, when the display panel does not carry out a display, the voltage application control means does not cause a voltage to be applied from the power supply to the polymer dispersed liquid crystal panel. This causes the polymer dispersed liquid crystal panel to scatter outside light on its surface, so that the display device gives a white appearance on its surface.

Thus, since, when the display device does not carry out a display, the display surface of the display device turns white, the display device can be made less conspicuous in a space than a conventional display device. Take the case of a display hung on a wall or embedded in a wall, for example. Since walls are mostly white and the display device gives a white appearance similar in color to such white walls, the display device does not spoil the whole appearance of a space (e.g., a room) in which it is placed, and can also help improve interior design.

The display device may be configured to further include a housing in which a backlight unit serving as a light source, a display panel provided with the display surface, and the polymer dispersed liquid crystal panel are placed in this order, wherein: the housing has a peripheral section covering a periphery of the polymer dispersed liquid crystal panel and forming the non-display region; and when the display panel does not carry out a display, the polymer dispersed liquid crystal panel takes on a same color as the peripheral section.

With this, when no image is displayed, the display device shows the same color on its surface because of the polymer dispersed liquid crystal panel and the peripheral section. Therefore, by making the same color an appropriate color other than black or silver, the display device can be made less conspicuous in a space than a convention display device having a display surface whose color includes black or silver.

The display device may be configured such that the color that the polymer dispersed liquid crystal panel takes on when the display panel does not carry out a display and the color of the peripheral section are white.

With this, when no image is displayed, the surface of the display device looks white. Take the case of a display hung on a wall or embedded in a wall, for example. Since walls are mostly white and the display device gives a white appearance similar in color to such white walls, the display device does not spoil the whole appearance of a room, and can also help improve interior design.

The display device may be configured such that the display panel and the polymer dispersed liquid crystal panel are joined to each other with a gel adhesive forming a gel layer sandwiched between the display panel and the polymer dispersed liquid crystal panel.

In general, there occurs reflection at the interface between substances having different refractive indices. Therefore, the presence of the air layer between the display panel and the polymer dispersed liquid crystal panel causes reflection of outside light on the surface of the liquid crystal panel, thus causing a decrease in visibility.

In order to prevent such reflection of outside light, the gel layer is formed between the polymer dispersed liquid crystal panel and the liquid crystal panel by joining the liquid crystal panel and the polymer dispersed liquid crystal panel to each other with a gel adhesive equivalent in refractive index to the liquid crystal panel and the polymer dispersed liquid crystal panel. This makes it possible to suppress reflection of outside light and reflection at the interface, thus making it possible to suppress a decrease in visibility of an image.

The display device may be configured such that the protective panel has a liquid crystal layer into which a dichroic dye has been added.

Further, the display device may be configured such that the polymer dispersed liquid crystal panel has a polymer dispersed liquid crystal layer into which a dichroic dye has been added.

The dichroic dye, dissolved in liquid crystals aligned in a given molecular arrangement, has its dye molecules aligned in parallel with the liquid crystal molecules. This allows the dichroic dye to change its orientation in accordance with a change in orientation of the liquid crystal molecules in the presence of an electric field, thus making it possible to change the amount of visible light that the dichroic dye absorbs.

Therefore, addition of the dichroic dye allows the protective panel and the polymer dispersed liquid crystal panel to switch between a transparent state and a colored state according to the presence or absence of a voltage applied.

The display device may be configured such that the protective panel has a liquid crystal layer into which cholesteric liquid crystals have been added.

Further, the display device may be configured such that the polymer dispersed liquid crystal panel has a polymer dispersed liquid crystal layer into which cholesteric liquid crystals have been added.

The cholesteric liquid crystals are liquid crystals whose molecules have a helical structure. In cases where the molecules have a helical structure of a given period with its helical axis perpendicular to the plane of a substrate and where the period of the helix is equal to a particular wavelength of light, light of that wavelength is reflected. Consequently, use of cholesteric liquid crystals equal in period to a particular wavelength renders a colored state since light of that wavelength is reflected; meanwhile, all light can be transmitted by laying the helical molecules of the cholesteric liquid crystals by the application of a voltage.

Therefore, addition of the cholesteric liquid crystals allows the protective panel and the polymer dispersed liquid crystal panel to switch between a transparent state and a colored state according to the presence or absence of a voltage applied.

The display device may be configured such that: the protective panel has a reflection preventing film that suppresses a decrease in visibility due to reflection of outside light; and the reflection preventing film is a moth-eye film.

Further, the display device may be configured such that: the polymer dispersed liquid crystal panel has a reflection preventing film that suppresses a decrease in visibility due to reflection of outside light; and the reflection preventing film is a moth-eye film.

In the display device, a moth-eye film is used as the reflection preventing film. The moth-eye film is a film obtained by periodically arranging, on a surface of a polymer film, tapered projections that are finer than the wavelength of light. Adoption of a film having such a shape causes a continuous change in through-thickness refractive index, thus allowing suppression of reflection of visible light.

In the display device, the moth-eye film may be a film obtained by periodically arranging, on a surface of a polymer film, tapered projections that are finer than the wavelength of light. Adoption of a film having such a shape causes a continuous change in through-thickness refractive index, thus allowing suppression of reflection of visible light.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

Since a display device of the present invention can be made less conspicuous in a space than a conventional display device, does not spoil the whole appearance of a space (e.g., a room) in which it is placed, and can help improve interior design, it can be suitable applied to various displays such as liquid crystal displays, plasma displays, and organic EL displays.

### REFERENCE SIGNS LIST

1, 21 Liquid crystal display (display device)
2 Liquid crystal panel (display panel)
2a Display part (display region)
3 Backlight unit
4 Housing
4a Peripheral section (non-display region)
5 PDLC panel (protective panel, polymer dispersed liquid crystal panel)
6 Air layer
7a Transparent electrode (first transparent electrode)
7b Transparent electrode (second transparent electrode)
8a Glass substrate (first glass substrate)
8b Glass substrate (second glass substrate)
9 PDLC layer (polymer dispersed liquid crystal layer)
10 Reflection preventing film
11a, 11b Transparent electrode
12 Color filter substrate
13 TFT substrate
14 Liquid crystal layer
15a, 15b Viewing angle compensation film
16a, 16b Polarizer
24 Housing (housing)
24a Peripheral section (peripheral section)
31 Voltage application control circuit (voltage application control means)

CS1, CS2, . . . CS(p−1), CSp Auxiliary capacitor line
G1, G2, . . . G(m−1), Gm Scanning line
PIX Pixel
S1, S2, . . . S(n−1), Sn Signal line

SW1 Switch

V1 Voltage supply (power supply)
51 Signal line driving circuit
52 Scanning line driving circuit
53 Control circuit
54 Auxiliary capacitor line driving circuit

1. A display device including a display surface formed by a display region and a non-display region, comprising:
a protective panel, which covers the display surface, and which, while directly transmitting incident light when a voltage is applied, scatters incident light when no voltage is applied; and
voltage application control means, which carries out such control that when a display is carried out on the display surface, a voltage is applied from a power supply to the protective panel, and when no display is carried out on the display surface, the voltage is not applied from the power supply to the protective panel.

2. The display device as set forth in claim 1, wherein the protective panel is a polymer dispersed liquid crystal panel.

3. The display device as set forth in claim 2, further comprising a housing in which a backlight unit serving as a light source, a display panel provided with the display surface, and the polymer dispersed liquid crystal panel are placed in this order, wherein:
the housing has a peripheral section covering a periphery of the polymer dispersed liquid crystal panel and forming the non-display region; and
when the display panel does not carry out a display, the polymer dispersed liquid crystal panel takes on a same color as the peripheral section.

4. The display device as set forth in claim 3, wherein the color that the polymer dispersed liquid crystal panel takes on when the display panel does not carry out a display and the color of the peripheral section are white.

5. The display device as set forth in claim 3, wherein the display panel and the polymer dispersed liquid crystal panel are joined to each other with a gel adhesive forming a gel layer sandwiched between the display panel and the polymer dispersed liquid crystal panel.

6. The display device as set forth in claim 1, wherein the protective panel has a liquid crystal layer into which a dichroic dye has been added.

7. The display device as set forth in claim 2, wherein the polymer dispersed liquid crystal panel has a polymer dispersed liquid crystal layer into which a dichroic dye has been added.

8. The display device as set forth in claim 1, wherein the protective panel has a liquid crystal layer into which cholesteric liquid crystals have been added.

9. The display device as set forth in claim 2, wherein the polymer dispersed liquid crystal panel has a polymer dispersed liquid crystal layer into which cholesteric liquid crystals have been added.

10. The display device as set forth in claim 1 wherein:
the protective panel has a reflection preventing film that suppresses a decrease in visibility due to reflection of outside light; and
the reflection preventing film is a moth-eye film.

11. The display device as set forth in claim 2, wherein:
the polymer dispersed liquid crystal panel has a reflection preventing film that suppresses a decrease in visibility due to reflection of outside light; and
the reflection preventing film is a moth-eye film.

12. The display device as set forth in claim 10, wherein the moth-eye film is a film obtained by periodically arranging, on a surface of a polymer film, tapered projections that are finer than a wavelength of light.
